(19) United States
(12) Patent Application Publication
(10) Pub. No.: US 2024/0241228 A1
(43) Pub. Date: Jul. 18, 2024

(54) LIGHT-EMITTING DEVICE AND RANGING DEVICE

(71) Applicant: SONY SEMICONDUCTOR SOLUTIONS CORPORATION, KANAGAWA (JP)

(72) Inventors: NAOKI MASUMITSU, KUMAMOTO (JP); KATSUHISA DAIO, KUMAMOTO (JP)

(21) Appl. No.: 18/684,242

(22) PCT Filed: Mar. 15, 2022
(86) PCT No.: PCT/JP2022/011731

§ 371 Date: Feb. 16, 2024

(30) Foreign Application Priority Data
Sep. 7, 2021 (JP) 2021-145489

(51) Int. Cl. G01S 7/484; G01S 7/4865; G01S 17/10

(52) U.S. Cl. CPC G01S 7/484; G01S 7/4865; G01S 17/10

(57) ABSTRACT

A light-emitting device according to the present technique includes: a light-emitting unit that emits light for ranging; a light receiving unit that receives light emitted from the light-emitting unit; and a control unit that calculates a target value of the driving current of the light-emitting unit on the basis of a light-receiving signal by the light receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period.

### TECHNICAL FIELD

The present technique relates to a light-emitting device provided with a light-emitting unit that emits light for ranging and a ranging device provided with a ranging unit that measures a distance to an object by receiving light emitted from the light-emitting unit and reflected by the object, and particularly relates to a calibration technique for a driving current value of a light-emitting unit.

### BACKGROUND ART

For example, a ranging device for ranging according to the ToF (Time Of Flight) method includes a light-emitting unit that emits light for ranging to an object of ranging.

For the light-emitting unit, for example, a light-emitting device such as a semiconductor laser is used. In order to properly correct a change of a light amount depending upon a temperature or the like, so-called APC (Auto Power Control) is performed. In this case, APC means processing for determining a driving current target value of the light-emitting unit such that the amount of light from the light-emitting unit reaches a target amount of light.

In the ranging device that measures distances on the basis of light reflected from an object, the light-emitting unit having a plurality of light-emitting channels is used to separately perform all-channel light-emitting ranging (normal ranging), in which all light-emitting channels emit light to measure distances over an area as a target of ranging and zone ranging, in which some of the light-emitting channels sequentially emit light to parts of the area as a target of ranging. In zone ranging, light is emitted from some of the light-emitting channels, so that a driving current target value may be determined for each of the light-emitting channels.

PTL 1 discloses a technique for performing APC on a light-emitting unit including a plurality of light-emitting channels while monitoring an amount of emitted light for each of the light-emitting channels.

### CITATION LIST

### Patent Literature

[PTL 1]
JP 2012-230180A

### SUMMARY

### Technical Problem

However, in the case of APC for each of the light-emitting channels, APC light is emitted for each of the light-emitting channels, which may increase power consumption.

The present technique has been devised in view of the above circumstances. An object of the present technique is to reduce power consumption in a device including a light-emitting unit that emits light for ranging.

### Solution to Problem

A light-emitting device according to the present technique includes: a light-emitting unit that emits light for ranging; a light-receiving unit that receives light emitted from the light-emitting unit; and a control unit that calculates a target value of the driving current of the light-emitting unit on the basis of a light-receiving signal by the light-receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period.

In this case, “basic irradiated light amount” means an amount of light to the object when the driving current value of the light-emitting unit is set at a constant value. “When the light-emitting unit is caused to emit light with a different basic irradiated light amount from the calculation light emission period” may specifically correspond to light emission by the light-emitting unit with a different number of light-emitting channels from the calculation light emission period. Alternatively, spot light emission (light emission in a dot pattern) may be used in contrast to surface emission in the calculation light emission period. In either case, the object is irradiated with different amounts of irradiated light if the driving current value of the light-emitting unit has the same value as in the calculation light emission period, which corresponds to “when the light-emitting unit is caused to emit light with a different basic irradiated light amount from the calculation light emission period”.

As described above, when the light-emitting unit is caused to emit light with a different basic irradiated light amount from the calculation light emission period, the light-emitting unit is caused to emit light by the driving current according to the corrected target value based on a difference in basic irradiation light amount from the calculation light emission period. Thus, also in the case of light emission with a different basic irradiated light amount from the calculation light emission period, a difference in basic irradiated light amount can be properly corrected, thereby driving the light-emitting unit to achieve a proper amount of irradiated light.

A ranging device according to the present technique includes: a light-emitting unit that emits light for ranging; a ranging unit that measures a distance to an object by receiving light emitted from the light-emitting unit and reflected by the object; a light-receiving unit that receives light emitted from the light-emitting unit; and a control unit that calculates a target value of the driving current of the light-emitting unit on the basis of a light-receiving signal by the light-receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period.

The ranging device configured thus can obtain the same effects as the light-emitting device according to the present technique.

### BRIEF DESCRIPTION OF DRAWINGS

FIG. 1 is a block diagram illustrating a configuration example of a ranging device configured with a light-emitting device as a first embodiment of the present technique.

FIG. 2 is a block diagram illustrating an example of the internal circuit configuration of a sensor unit according to the embodiment.

FIG. 3 is an equivalent circuit diagram of a pixel of the sensor unit according to the embodiment.

FIG. 4 is an explanatory drawing of an electrical configuration example of a light-emitting unit according to the first embodiment.

FIG. 5 illustrates a structural configuration example of the light-emitting unit and a control unit according to the first embodiment.

FIG. 6 is an explanatory drawing of zone ranging.

FIG. 7 is an explanatory drawing of differences in distance to a light-receiving element among light-emitting channels.

FIG. 8 is an explanatory drawing of a configuration in which the light-emitting elements are provided for the respective light-emitting channels.

FIG. 9 is a flowchart of a specific procedure example for implementing a light emission control technique as the first embodiment.

FIG. 10 is an explanatory drawing of a light emission technique during APC according to a modification example of the first embodiment.

FIG. 11 is a flowchart showing a specific procedure example for implementing a light emission control technique as a modification example of the first embodiment.

FIG. 12 is an explanatory drawing of a ranging technique using normal ranging with surface emission and spot ranging.

FIG. 13 is a block diagram for explaining a configuration example of a ranging device according to a second embodiment.

FIG. 14 is an explanatory drawing of a structural configuration example of a light-emitting unit provided for the ranging device according to the second embodiment.

FIG. 15 is a flowchart showing a specific procedure example for implementing a light emission control technique according to the second embodiment.

### DESCRIPTION OF EMBODIMENTS

Hereinafter, embodiments according to the present technique will be described in the following order with reference to the accompanying drawings.

### 1. First Embodiment

### (1-1. Configuration Outline of Ranging Device)

### (1-2. Light-Emitting Unit)

### (1-3. Zone Ranging)

### (1-4. Control Method as Embodiment)

### 2. Second Embodiment

### <3. Modification Example>

### <4. Summary of Embodiments>

### <5. Present Technique>

### 1. First Embodiment

### (1-1. Configuration Outline of Ranging Device)

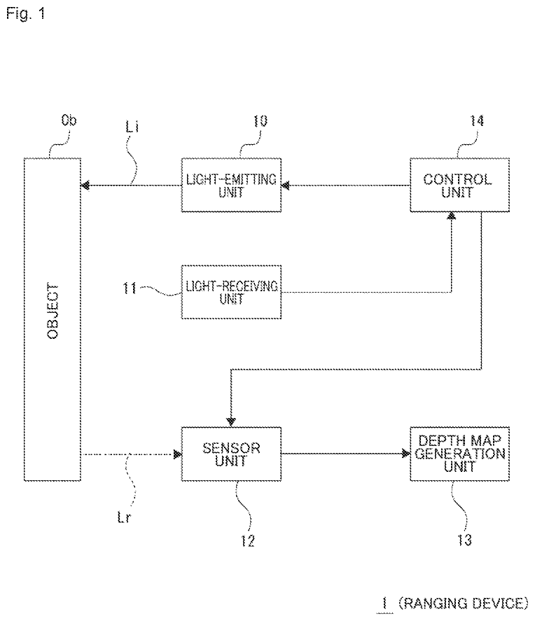

FIG. 1 is a block diagram illustrating a configuration example of a ranging device 1 configured with a light-emitting device as a first embodiment of the present technique.

In FIG. 1, the light-emitting device as the first embodiment includes at least a light-emitting unit 10, a light-receiving unit 11, and a control unit 14.

As illustrated in FIG. 1, the ranging device 1 according to the embodiment includes the light-emitting unit 10 that emits light for ranging, a sensor unit 12 configured to receive, according to the ToF (Time of Flight) method, light emitted from the light-emitting unit 10 and reflected by an object Ob, a depth map generation unit 13, the light-receiving unit 11, and the control unit 14.

The ranging device 1 according to the present embodiment can measure a distance for each pixel according to the ToF method and obtain a depth map. In this case, “depth map” means an image that indicates distance information for each pixel.

In this example, the ranging device 1 is configured to measure a distance according to the indirect ToF method. The indirect ToF method is a ranging method that calculates a distance to the object Ob on the basis of a phase difference between irradiated light Li on the object Ob and reflected light Lr obtained by reflecting the irradiated light Li on the object Ob.

As the ranging method, the direct ToF method may be adopted. Also in the direct ToF method, a distance is measured on the basis of the reflected light Lr from the object Ob. The direct ToF method is different from the indirect ToF method in that a distance is determined by measuring a time difference from the emission of the irradiated light Li to the reception of the reflected light Lr instead of a phase difference between the irradiated light Li and the reflected light Lr.

The light-emitting unit 10 includes one or more light-emitting elements (light-emitting elements 101 described later) as light sources, and emits the irradiated light Li to the object Ob. In this example, the light-emitting unit 10 emits IR light having a wavelength ranging from, for example, 750 nm to 1400 nm as the irradiated light Li.

The light-emitting unit 10 will be specifically described later.

The light-receiving unit 11 receives light emitted from the light-emitting unit 10. The light-receiving unit 11 is used for monitoring light emitted from the light-emitting unit 10 in the APC (Auto Power Control) of the light-emitting unit 10.

The light-receiving unit 11 will be specifically described later.

The sensor unit 12 receives the reflected light Lr. Specifically, the reflected light Lr is received such that a phase difference between the reflected light Lr and the irradiated light Li can be detected.

As will be described later, the sensor unit 12 of this example includes a pixel array unit 111 in which a plurality of pixels Px are two-dimensionally arranged. Each of the pixels Px includes a photoelectric conversion element (photodiode PD), a first transfer gate element (transfer transistor TG-A), and a second transfer gate element (transfer transistor TG-B), the transfer gate elements being provided for transferring charges accumulated in the photoelectric conversion element. Light is received for each of the pixels Px according to the indirect ToF method.

The control unit 14 is configured as, for example, an electric circuit unit including an IC (Integrated Circuit) and controls an operation of emitting the irradiated light Li from the light-emitting unit 10 and an operation of the sensor unit 12.

In the case of ranging according to the ToF methods including the indirect ToF method, intensity-modulated light is used as the irradiated light Li such that the intensity changes in a predetermined cycle. Specifically, in this example, pulsed light is repeatedly emitted as the irradiated light Li in the predetermined cycle. Hereinafter, the light-emission cycle of the pulsed light will be referred to as a “light-emission cycle C1”. When pulsed light is repeatedly emitted in the light-emission cycle C1, a period between timings at which the emission of the pulsed light is started will be referred to as a “single modulation period Pm” or simply referred to as a “modulation period Pm”.

The control unit 14 controls the light emitting operation of the light-emitting unit 10 such that the irradiated light Li is emitted only during a predetermined light emission period for each modulation period Pm.

In the ToF method, the light-emission cycle C1 is assumed to be relatively fast, ranging from, for example, several tens to several hundreds of MHz.

As is known, in the indirect ToF method, signal charges accumulated in the photoelectric conversion elements of the pixels Px of the sensor unit 12 are distributed between two floating diffusions (FDs) by the first transfer gate element and the second transfer gate element, which are alternately turned on. In this case, the cycle at which the first transfer gate element and the second transfer gate element are alternately turned on is the same cycle as the light-emission cycle C1 of the light-emitting unit 10. In other words, the first transfer gate element and the second transfer gate element are each turned on once in each modulation period Pm, and the distribution of the signal charges to the two floating diffusions is repeated for each modulation period Pm.

For example, the transfer transistor TG-A serving as the first transfer gate element is turned on in the light emission period of the irradiated light Li in the modulation period Pm, and the transfer transistor TG-B serving as the second transfer gate element is turned on in a non-light-emission period of the irradiated light Li in the modulation period Pm.

In addition, when IQ modulation (I: In-phase (in-phase component), Q: Quadrature (quadrature component)) are applied in the ranging operations, the transfer transistor TG-A may be turned on/off in a cycle in which the phase is shifted by 90 degrees relative to the light-emission cycle of the irradiated light Li, and the transfer transistor TG-B may be turned on/off in a cycle in which the phase is shifted by 270 degrees relative to the cycle of the irradiated light Li.

As described above, the light-emission cycle C1 is assumed to be relatively fast, and thus a relatively small signal charge is accumulated in each floating diffusion by a distribution using the first and second transfer gate elements. Hence, in the indirect ToF method, the emission of the irradiated light Li is repeated several thousands to several tens of thousands of times for each distance measurement (i.e., when obtaining a single depth map). In the sensor unit 12, the distribution of the signal charge to each floating diffusion using the first and second transfer gate elements is repeated while the irradiated light Li is repeatedly emitted.

As is understood from the foregoing descriptions, in the sensor unit 12, the first transfer gate element and the second transfer gate element are driven for each pixel Px at timings based on the light-emission cycle of the irradiated light Li. For this reason, the control unit 14 controls a light receiving operation by the sensor unit 12 and a light emitting operation by the light-emitting unit 10 based on a common clock.

Moreover, the control unit 14 performs APC processing on the basis of a light-receiving signal of the light-receiving unit 11 when calibration is to be performed on the driving current value of the light-emitting unit 10. The APC processing is processing for determining a target value of the driving current of the light-emitting unit 10 and will be specifically described later.

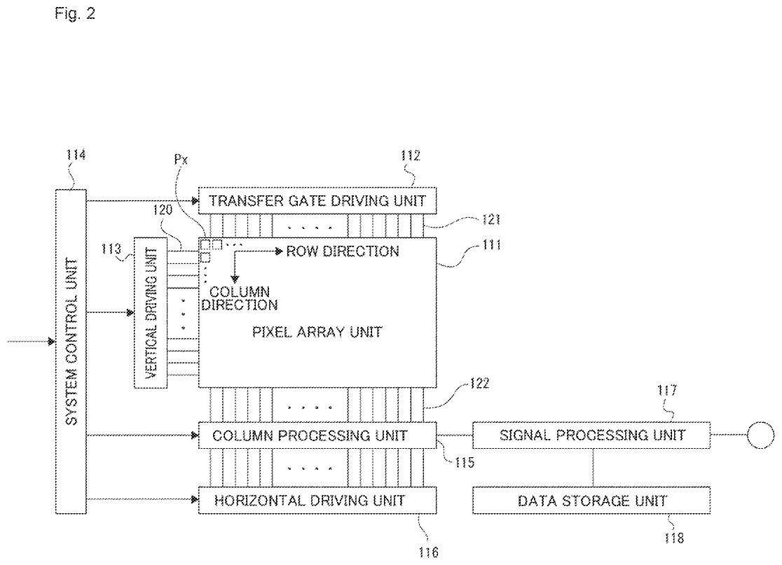

The depth map generation unit 13 generates a depth map on the basis of the charge signals accumulated in each floating diffusion through the distribution operation in the sensor unit 12. By performing predetermined computations according to the indirect ToF method for the charge signals accumulated in each floating diffusion, a distance (a distance to an object) can be calculated for each pixel Px, so that a depth map indicating distance information can be obtained for each pixel Px. As a method for calculating distance information according to the indirect ToF method on the basis of two detection signals (detection signals for the respective floating diffusions) for each pixel Px, a known method is used and thus the description thereof is omitted. FIG. 2 is a block diagram illustrating an example of the internal circuit configuration of the sensor unit 12.

As illustrated in FIG. 2, the sensor unit 12 includes the pixel array unit 111, a transfer gate driving unit 112, a vertical driving unit 113, a system control unit 114, a column processing unit 115, a horizontal driving unit 116, a signal processing unit 117, and a data storage unit 118.

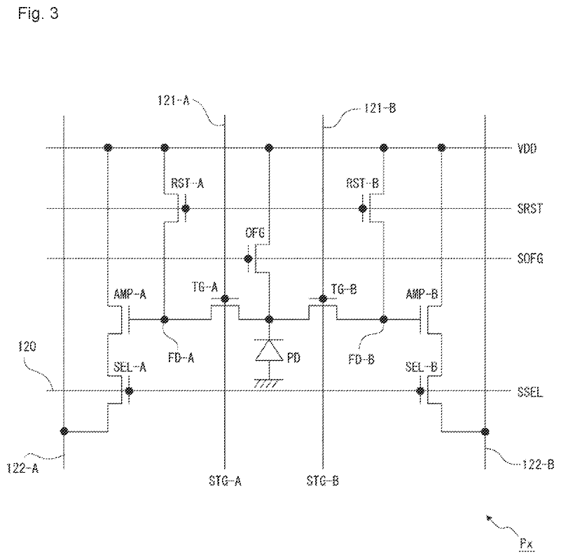

The pixel array unit 111 is configured with the plurality of pixels Px two-dimensionally arranged in a matrix in the row direction and the column direction. Each pixel Px has a photodiode PD serving as a photoelectric conversion element, which will be described later. The pixel Px will be specifically described later with reference to FIG. 3.

In this configuration, the row direction is a direction along which the pixels Px are horizontally arranged, and the column direction is a direction along which the pixels Px are vertically arranged. In FIG. 2, the row direction is the horizontal direction, and the column direction is the vertical direction.

In the pixel array unit 111, for a matrix pixel array, a row drive line 120 is provided along the row direction for each pixel row, and two gate drive lines 121 and two vertical signal lines 122 are provided along the column direction for each pixel column. For example, the row drive line 120 transfers a drive signal for driving when reading a signal from the pixel Px. Note that in FIG. 2, the row drive line 120 is indicated as a wire but is not limited to a single wire. One end of the row drive line 120 is connected to an output end of the vertical driving unit 113, the output end corresponding to each row.

The system control unit 114 includes a timing generator for generating various timing signals, and controls the driving of the transfer gate driving unit 112, the vertical driving unit 113, the column processing unit 115, the horizontal driving unit 116, and the like on the basis of the various timing signals generated by the timing generator.

Under the control of the system control unit 114, the transfer gate driving unit 112 drives the two transfer gate elements provided for each pixel Px, through the two gate drive lines 121 provided for each pixel column as described above.

As described above, the two transfer gate elements are alternately turned on for each modulation period Pm. Accordingly, the system control unit 114 supplies a clock inputted from the control unit 14 to the transfer gate driving unit 112, and the transfer gate driving unit 112 drives the two transfer gate elements on the basis of the clock.

The vertical driving unit 113 is configured with, for example, a shift register and an address decoder and drives the pixels Px of the pixel array unit 111 simultaneously or for each row. In other words, the vertical driving unit 113 constitutes a driving unit that controls the operation of each pixel Px of the pixel array unit 111 along with the system control unit 114 that controls the vertical driving unit 113.

Detection signals outputted (read) from the pixels Px in a pixel row in response to driving control by the vertical driving unit 113, specifically, signals (charge signals) corresponding to signal charges accumulated in the two floating diffusions provided for each pixel Px are inputted to the column processing unit 115 through the corresponding vertical signal line 122. The column processing unit 115 performs predetermined signal processing on the detection signals read from each pixel Px through the vertical signal line 122 and temporarily holds the detection signals having been subjected to the signal processing. Specifically, the column processing unit 115 performs noise reduction according to CDS (Correlated Double Sampling) or A/D (Analog to Digital) conversion or the like as signal processing.

In this configuration, the two detection signals (the detection signal for each floating diffusion) are read once from each pixel Px each time the irradiated light Li is repeatedly emitted a predetermined number of times (each time the irradiated light is repeatedly emitted several thousands to several tens of thousands times as described above).

Accordingly, the system control unit 114 controls the vertical driving unit 113 on the basis of the clock such that the timing at which the detection signals are read from each pixel Px is the timing at which the irradiated light Li is repeatedly emitted a predetermined number of times.

The horizontal driving unit 116 is configured with a shift register and an address decoder or the like and sequentially selects unit circuits corresponding to a pixel column of the column processing unit 115. Through selective scanning by the horizontal driving unit 116, the detection signals subjected to the signal processing for each unit circuit in the column processing unit 115 are output in sequence.

The signal processing unit 117 has at least an arithmetic processing function and performs predetermined signal processing on the detection signals outputted from the column processing unit 115.

The data storage unit 118 temporarily stores data required for signal processing performed by the signal processing unit 117.

FIG. 3 illustrates an equivalent circuit of the pixel Px two-dimensionally arranged in the pixel array unit 111.

The pixel Px includes the photodiode PD serving as a photoelectric conversion element and an OF (overflow) gate transistor OFG. The pixel Px also includes two transfer transistors TG serving as transfer gate elements, two floating diffusions FD, two reset transistors RST, two amplifying transistors AMP, and two selection transistors SEL.

When making distinctions among the two transfer transistors TG, the two floating diffusions FD, the two reset transistors RST, the two amplifying transistors AMP, and the two selection transistors SEL that are provided in the pixel Px, as illustrated in FIG. 3, these elements are denoted as transfer transistors TG-A and TG-B, floating diffusions FD-A and FD-B, reset transistors RST-A and RST-B, amplifying transistors AMP-A and AMP-B, and selection transistors SEL-A and SEL-B.

The OF gate transistor OFG, the transfer transistor TG, the reset transistor RST, the amplifying transistor AMP, and the selection transistor SEL are configured with, for example, N-type MOS transistors.

The OF gate transistor OFG is brought into conduction when an OF gate signal SOFG supplied to the gate is turned on. When the OF gate transistor OFG is brought into conduction, the photodiode PD is clamped to a predetermined reference potential VDD, and the accumulated charge is reset.

The OF gate signal SOFG is supplied from, for example, the vertical driving unit 113.

The transfer transistor TG-A is brought into conduction when a transfer drive signal STG-A supplied to the gate is turned on, and the signal charge accumulated in the photodiode PD is transferred to the floating diffusion FD-A. The transfer transistor TG-B is brought into conduction when a transfer drive signal STG-B supplied to the gate is turned on, and the signal charge accumulated in the photodiode PD is transferred to the floating diffusion FD-B.

The transfer drive signals STG-A and STG-B are supplied from the transfer gate driving unit 112 through gate drive lines 121-A and 121-B, respectively, each of which is provided as one of the gate drive lines 121 illustrated in FIG. 2.

The floating diffusions FD-A and FD-B are charge holding units that temporarily hold the charge transferred from the photodiode PD.

The reset transistor RST-A is brought into conduction when a reset signal SRST supplied to the gate is turned on, and the potential of the floating diffusion FD-A is reset to the reference potential VDD. Likewise, the reset transistor RST-B is brought into conduction when the reset signal SRST supplied to the gate is turned on, and the potential of the floating diffusion FD-B is reset to the reference potential VDD.

The reset signal SRST is supplied from, for example, the vertical driving unit 113.

The amplifying transistor AMP-A having the source connected to a vertical signal line 122-A via the selection transistor SEL-A and the drain connected to the reference potential VDD (constant current source) constitutes a source follower circuit. The amplifying transistor AMP-B having the source connected to a vertical signal line 122-B via the selection transistors SEL-B and the drain connected to the reference potential VDD (constant current source) constitutes a source follower circuit.

In this configuration, each of the vertical signal lines 122-A and 122-B is provided as one of the vertical signal lines 122 illustrated in FIG. 2.

The selection transistor SEL-A is connected between the source of the amplifying transistor AMP-A and the vertical signal line 122-A and is brought into conduction when a selection signal SSEL supplied to the gate is turned on, whereupon the charge held in the floating diffusion FD-A is outputted to the vertical signal line 122-A through the amplifying transistor AMP-A. The selection transistor SEL-B is connected between the source of the amplifying transistor AMP-B and the vertical signal line 122-B and is brought into conduction when the selection signal SSEL supplied to the gate is turned on, whereupon the charge held in the floating diffusion FD-B is outputted to the vertical signal line 122-B through the amplifying transistor AMP-A.

The selection signal SSEL is supplied from the vertical driving unit 113 through the row drive line 120.

The operations of the pixel Px will be briefly described below.

Before starting light reception, a resetting operation for resetting the charge of the pixel Px is performed on all the pixels. In other words, for example, the OF gate transistor OFG, the reset transistors RST, and the transfer transistors TG are turned on (brought into conduction) and the accumulated charges of the photodiode PD and the floating diffusions FD are reset.

After the reset of the accumulated charge, a light receiving operation for measuring a distance is performed on all the pixels. In this case, the light receiving operation means a light receiving operation performed for a single measurement of a distance. In other words, during the light receiving operation, an operation of alternately turning on the transfer transistors TG-A and TG-B is repeated a predetermined number of times (about several thousands to several tens of thousands times in this example). The period of the light receiving operation performed for a measurement of a distance is denoted as a “light-receiving period Pr”.

During the light-receiving period Pr, in a single modulation period Pm of the light-emitting unit 10, for example, the on-period of the transfer transistor TG-A (that is, the off-period of the transfer transistor TG-B) is continued over the light emission period of the irradiated light Li, and then the remaining period, that is, the non-light-emission period of the irradiated light Li is assumed to be the on-period of the transfer transistor TG-B (that is, the off-period of the transfer transistor TG-A). In other words, in the light-receiving period Pr, the operation of distributing the charge in the photodiode PD to the floating diffusions FD-A and FD-B in a single modulation period Pm is repeated a predetermined number of times.

In addition, at the end of the light-receiving period Pr, the pixels Px in the pixel array unit 111 are line-sequentially selected. In the selected pixel Px, the selection transistors SEL-A and SEL-B are turned on. Thus, the charge accumulated in the floating diffusion FD-A is outputted to the column processing unit 115 through the vertical signal line 122-A. Likewise, the charge accumulated in the floating diffusion FD-B is outputted to the column processing unit 115 through the vertical signal line 122-B.

As described above, the light receiving operation is completed, and then the subsequent light receiving operation is performed, starting from a resetting operation.

The reflected light Lr received by the pixel Px is delayed from the timing of emission of the irradiated light Li from the light-emitting unit 10 according to a distance to the object Ob. The delay time according to the distance to the object Ob changes the distribution ratio of the charges accumulated in the two floating diffusions FD-A and FD-B, so that the distance to the object Ob can be determined from the distribution ratio of the charges accumulated in the two floating diffusions FD-A and FD-B.

In the foregoing example, a so-called two-phase method is performed as ranging according the indirect ToF method. Specifically, a distance is calculated from two types of light-receiving signals (charge signals accumulated in the floating diffusions FD-A and FD-B) obtained by distributing the charges using transfer drive signals STG having phase differences of 0 degrees and 180 degrees relative to the light-emitting signal.

However, a so-called four-phase method can also be used as ranging according to the indirect ToF method. In the four-phase method, a ranging operation is performed on the basis of the above-mentioned IQ modulation, light-receiving signals having phase differences of 90 degrees and 270 degrees relative to the light-emitting signal are used in addition to light-receiving signals having phase differences of 0 degrees and 180 degrees.

In this case, in the light-receiving period Pr, as described above, the operations of distributing the charges to the floating diffusions FD-A and FD-B using the transfer drive signal STG-A having a phase difference of 0 degrees relative to the light-emitting signal and the transfer drive signal STG-B having a phase difference of 180 degrees are performed to obtain the light-receiving signals having phase differences of 0 degrees and 180 degrees. Furthermore, operations of distributing the charges to the floating diffusions FD-A and FD-B using the transfer drive signal STG-A having a phase difference of 90 degrees relative to the light-emitting signal and the transfer drive signal STG-B having a phase difference of 270 degrees are performed to obtain light-receiving signals having phase differences of 90 degrees and 270 degrees.

Ranging operations according to the four-phase method using the four types of light-receiving signals with phase differences of 0 degrees, 180 degrees, 90 degrees, and 270 degrees are publicly known, and thus the detailed description thereof is omitted.

### (1-2. Light-Emitting Unit)

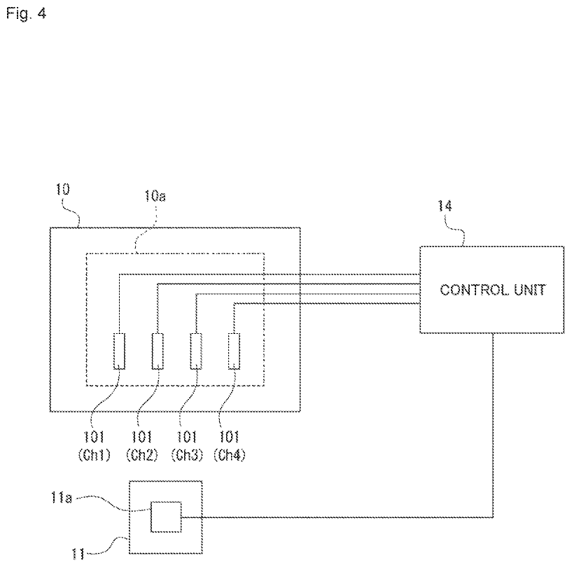

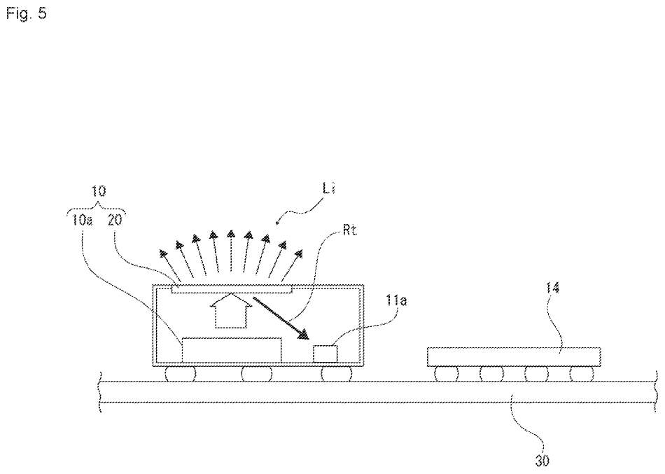

Referring to FIGS. 4 and 5, a configuration example of the light-emitting unit 10 will be described below.

FIG. 4 is an explanatory drawing of an electrical configuration example of the light-emitting unit 10. The control unit 14 and the light-receiving unit 11 in FIG. 1 are illustrated along with an example of the electrical internal configuration of the light-emitting unit 10.

As shown in FIG. 4, the light-emitting unit 10 includes an emission unit 10a configured with a plurality of light-emitting elements 101. A semiconductor light-emitting element is used as the light-emitting element 101. Specifically, in this example, a VCSEL (Vertical Cavity Surface Emitting Laser) is used as the light-emitting element 101.

In this example, the emission unit 10a is configured as a semiconductor chip having the plurality of light-emitting elements 101. In other words, the light-emitting elements 101 are formed on the same chip in this example.

In this example, the light-emitting elements 101 each constitute a light-emitting channel Ch for irradiating each zone in a ranging area with the irradiated light Li in a time sharing manner in zone ranging, which will be described later. Specifically, in this example, the emission unit 10a includes the four light-emitting elements 101, each constituting the light-emitting channel Ch. As will be described later, in zone ranging, a ranging area is divided into zones as many as light-emitting channels Ch, and the zones are sequentially irradiated with the irradiated light Li in a time sharing manner according to the corresponding light-emitting channels Ch.

When making distinctions among the four light-emitting channels Ch, as indicated by brackets in FIG. 4, the channels are denoted as “Ch1”, “Ch2”, “Ch3”, and “Ch4” with numbers added to the tail of “Ch”.

In this example, the light-emitting channel Ch is configured with only one of the light-emitting elements 101. This configuration is merely exemplary. The light-emitting channel Ch may include the plurality of light-emitting elements 101.

The control unit 14 is configured to separately drive the light-emitting elements 101. In the emission unit 10a of this example, the anodes (or cathodes) of the light-emitting elements 101 formed by VCSELs are connected in common, and a common power supply is connected to the light-emitting elements 101, though the connection is not illustrated. The control unit 14 including driver circuits for the respective light-emitting elements 101 controls on/off of a transistor in the driver circuit, thereby switching whether to pass a driving current from the common power supply to each of the light-emitting elements 101. In other words, the on/off control of light emission can be performed for each of the light-emitting elements 101.

In FIG. 4, the light-receiving unit 11 includes a light-receiving element 11a. As the light-receiving element 11a, for example, a photodiode is used.

In this example, the light-emitting unit 10 includes the plurality of light-emitting channels Ch, whereas the light-receiving unit 11 includes the single light-receiving element 11a.

FIG. 5 illustrates a structural configuration example of the light-emitting unit 10 and the control unit 14.

As illustrated in FIG. 5, in the ranging device 1 of this example, a semiconductor device (semiconductor package) in which the emission unit 10a and the light-receiving element 11a are disposed and a semiconductor device serving as the control unit 14 are mounted on a circuit board 30.

As illustrated in FIG. 5, structurally, the light-emitting unit 10 is configured with a diffuser 20 for diffusing light emitted from the emission unit 10a. The diffuser 20 is configured with, for example, a DOE (Diffractive Optical Element).

Light emitted from the emission unit 10a and diffused by the diffuser 20 is emitted to the object Ob as the irradiated light Li in FIG. 1.

In this configuration, light emitted from the emission unit 10a is partially reflected by the diffuser 20 (reflected light Rt in FIG. 5). The light-receiving element 11a is located to receive the reflected light Rt. Specifically, during APC processing, a driving current target value is calculated on the basis of the light-receiving signal of the reflected light Rt.

### (1-3. Zone Ranging)

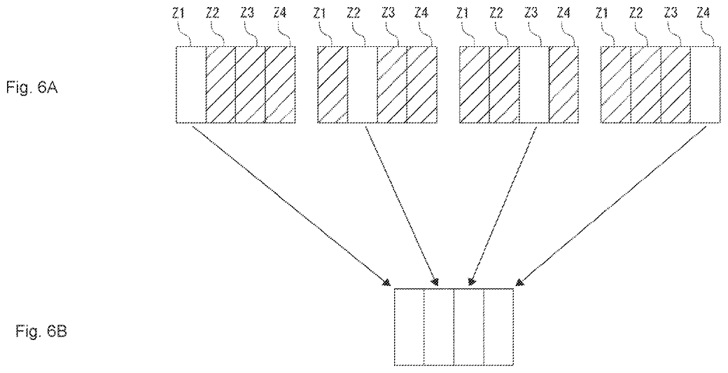

FIG. 6 is an explanatory drawing of zone ranging.

Zone ranging is a ranging technique that can measure a distance to an object in a remoter location (that is, a maximum ranging distance is extended) than normal zoning in which the irradiated light Li is emitted over a ranging area to measure a distance. In the present embodiment, the ranging device 1 has a ranging mode for performing the normal ranging (hereinafter referred to as “normal ranging mode”) and a ranging mode for performing zone ranging (hereinafter referred to as “zone ranging mode”). The normal ranging and the zone ranging can be switched and performed.

As described above, in zone ranging, a ranging area is divided into a plurality of zones Z, and the corresponding light-emitting channel Ch is caused to emit light to measure a distance in each of the zones Z (see FIG. 6A). Specifically, in this example, the zone is divided into four zones Z1, Z2, Z3, and Z4 as many as the four light-emitting channels Ch. Ranging of the zone Z1 is performed only by light emission of the light-emitting channel Ch1 that is the corresponding light-emitting channel Ch, and ranging of the zone Z2 is performed only by light emission of the light-emitting channel Ch2 that is the corresponding light-emitting channel Ch. Likewise, ranging of the zone Z3 is performed only by light emission of the light-emitting channel Ch3 that is the corresponding light-emitting channel Ch, and ranging of the zone Z4 is performed only by light emission of the light-emitting channel Ch4 that is the corresponding light-emitting channel Ch.

In zone ranging, the results of ranging obtained from the respective zones Z are combined to obtain the result of ranging of the overall ranging area, that is, a depth map (see FIG. 6B).

In this case, in order to secure safety, for example, the protection of the eyes of a subject, a predetermine upper limit is to be set on an amount of irradiated light per unit time for the ranging area.

For example, in the case of normal ranging, if an amount of irradiated light is “1” in each zone Z, an amount of irradiated light per unit time for the ranging area can be expressed as “4”. If “4” is the upper limit of an amount of irradiated light, the upper limit of an amount of irradiated light in each zone Z is “1” in normal ranging.

In the case of zone ranging, only one zone Z is irradiated with light per unit time. Thus, if the upper limit of an amount of irradiated light is “4” for the ranging area, each zone Z can be irradiated with light of “4”. In other words, the intensity of irradiated light for each zone Z can be raised higher than in normal ranging, allowing the irradiated light Li to reach an object in a remoter location.

Thus, the maximum ranging distance can be larger than that of normal ranging.

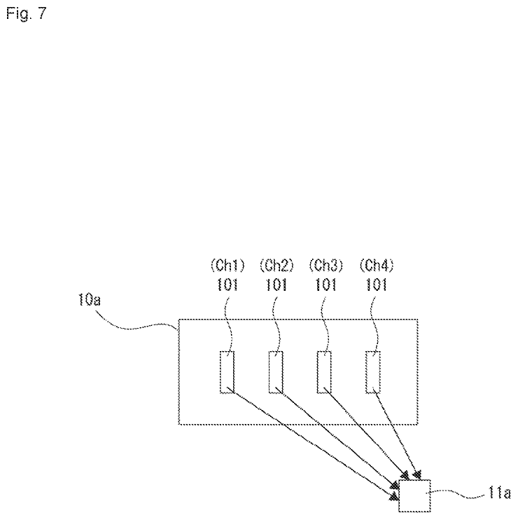

In the case of irradiation with the irradiated light Li for each of the light-emitting channels Ch as in zone ranging, a target value of driving current is to be determined for each of the light-emitting channels Ch. However, if light is received for APC only with the single light-receiving element 11a as illustrated in FIG. 7, it is difficult to calculate an accurate target value because of the light-emitting channels Ch at different distances to the light-receiving element 11a.

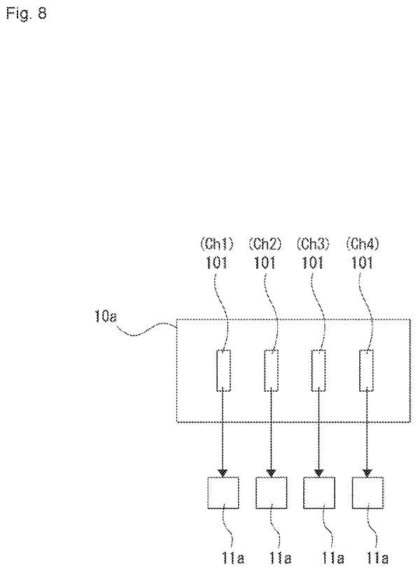

As illustrated in FIG. 8, the provision of the light-receiving element 11a for each of the light-emitting channels Ch can eliminate a distance difference shown in FIG. 7, thereby calculating an accurate target value for each of the light-emitting channels Ch. In this case, however, the plurality of light receiving elements 11a need to be provided, leading to upsizing and cost increase of the ranging device 1.

### 1-4. Control Method as Embodiment

Thus, in a method adopted in the present embodiment, when the light-emitting unit 10 is caused to emit light with a different basic irradiated light amount from a calculation light emission period, during which the light-emitting unit 10 is caused to emit light for calculating a target value, the light-emitting unit 10 is caused to emit light by a driving current according to a corrected target value that is obtained by correcting the target value on the basis of a difference in basic irradiation light amount from the calculation light emission period.

In this case, “basic irradiated light amount” means an amount of light to the object Ob when the driving current value of the light-emitting unit 10 is set at a constant value. In the first embodiment where the light-emitting unit 10 includes the plurality of light-emitting channels Ch, “when the light-emitting unit 10 is caused to emit light with a different basic irradiated light amount from a calculation light emission period” corresponds to light emission by the light-emitting unit 10 with a different number of light-emitting channels from the calculation light emission period.

Specifically, in the present embodiment, the corrected target value is used as a target value for zone ranging. More specifically, in the present example, a corrected target value is obtained by correcting a target value, which is determined for normal ranging with light emission of all the light-emitting channels Ch, by a coefficient determined on the basis of a difference between the number of light-emitting channels Ch to emit light during normal ranging and the number of light-emitting channels Ch to emit light during zone ranging, and the corrected target value is used as a target value of driving current during zone ranging.

At this point, APC is performed for normal ranging with light emission of all the light-emitting channels Ch. Moreover, the corrected target value is a value determined by correcting a target value, which is obtained by APC for normal ranging, according to a difference in the number of light-emitting channels Ch, specifically, a value obtained by a multiplication using the total number of light-emitting channels Ch in the light-emitting unit 10 as a coefficient. Thus, in zone ranging, the light-emitting channels Ch can emit light with a proper amount of irradiated light, at which “4” is obtained as the intensity of irradiated light, thereby improving the ranging accuracy of zone ranging.

As described above, APC is performed with light emission of all the light-emitting channels Ch. Thus, differences in distance to the light-receiving element 11a among the light-emitting channels Ch can be cancelled out and a proper driving current target value can be calculated for light emission of all the light-emitting channels Ch. Moreover, during zone ranging, the driving current value of the light-emitting unit 10 is set at a corrected target value obtained by correcting a driving current target value, which is determined by APC for light emission of all the light-emitting channels Ch, by a coefficient. This can set a driving current value to a proper value for each of the light-emitting channels Ch, thereby improving the ranging accuracy of zone ranging.

Furthermore, this eliminates the need for providing the light-receiving element 11a for each of the light-emitting channels Ch, achieving downsizing and cost reduction of the ranging device 1.

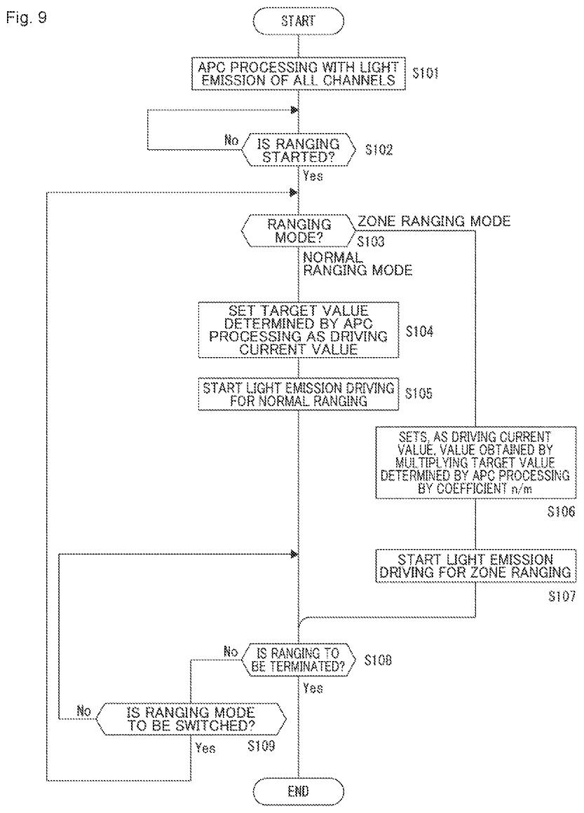

FIG. 9 is a flowchart showing a specific procedure example for implementing a light emission control technique as the foregoing first embodiment. Specifically, FIG. 9 shows an example of a procedure to be performed by the control unit 14 in FIG. 1.

First, in step S101, the control unit 14 performs APC processing with light emission of all the channels. In other words, APC processing is performed on the basis of the light-receiving signal of the light-receiving unit 11, the light-receiving signal being obtained by light emission of all the light-emitting channels Ch in the light-emitting unit 10.

The APC processing only needs to be performed as processing for determining a driving current target value for setting an amount of irradiated light from the light-emitting unit 10 to a target amount of irradiation light, and the specific processing technique is not particularly limited. As a specific example, a technique for calculating a target current (ILD_T) as a target value is available as disclosed in, for example, reference document 1.
Reference document 1: JP 2019-41201A

In step S102 subsequent to step S101, the control unit 14 waits for the start of ranging. When it is determined that ranging is started, the processing advances to step S103 to determine a ranging mode. Specifically, whether the ranging mode is the normal ranging mode or the zone ranging mode is determined.

In step S103, if it is determined that the ranging mode is the normal ranging mode, the control unit 14 advances to step S104, sets the target value, which is determined in the APC processing (S101), as a driving current value, and starts light emission driving for normal ranging in subsequent step S105. In other words, for all the light-emitting channels Ch of the light-emitting unit 10, a light emitting operation (a light emitting operation by the repeated light emission) for ranging is started by the driving current value set in step S104.

The control unit 14 advances the processing to step S108 in response to the execution of the processing of step S105.

In step S103, if it is determined that the ranging mode is the zone ranging mode, the control unit 14 advances to step S106 and sets, as a driving current value, a value obtained by multiplying the target value determined by the APC processing by a coefficient n/m.

In this case, n is the number of light-emitting channels Ch for light emission in the calculation light emission period. In this example, n is “4”, the total number of the light-emitting channels Ch. Moreover, m is the number of light-emitting channels Ch for light emission during partial light-emitting ranging in which only some of the light-emitting channels Ch are caused to emit light to measure a distance. In this example, m is the number of light-emitting channels Ch for light emission during zone ranging and is specifically “1”. In other words, in the processing of step S106, a value obtained by multiplying the target value determined by the APC processing by “4” is set as a driving current value.

In step S107 subsequent to step S106, the control unit 14 starts light emission driving for zone ranging. Specifically, processing for performing a light emitting operation (a light emitting operation by the repeated light emission) for ranging by the driving current value set in step S104 is started sequentially for each channel from the light-emitting channel Ch1 to the light-emitting channel Ch4.

The control unit 14 advances the processing to step S108 in response to the execution of the processing of step S107.

In step S108, the control unit 14 determines whether to terminate ranging. If it is determined that ranging is not to be terminated, the control unit 14 advances to step S109 and determines whether to switch the ranging mode.

If it is determined that the ranging mode is not to be switched, the control unit 14 returns to step S108. In other words, steps S108 and S109 form a loop for waiting for the completion of ranging or switching of the ranging mode.

If it is determined that the ranging mode is to be switched in step S109, the control unit 14 returns to step S103. Thus, proper processing is performed according to the ranging mode after switching. The proper processing is corresponding processing during the normal ranging described in step S104 and step S105 or corresponding processing during the zone ranging described in steps S106 and S107.

If it is determined that ranging is to be terminated in step S108, the control unit 14 terminates the series of processing in FIG. 9.

In the foregoing example, all the light-emitting channels Ch are caused to emit light during APC. When a proper driving current target value is obtained, light emission of all the light-emitting channels Ch is not always necessary during APC.

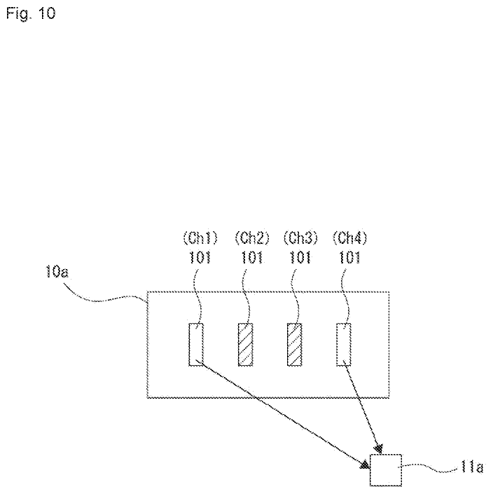

For example, as illustrated in FIG. 10, only the light-emitting channel Ch closest to the light-receiving element 11a and the light-emitting channel Ch remotest from the light-receiving element 11a may be caused to emit light.

Even if only the light-emitting channel Ch closest to the light-receiving element 11a and the light-emitting channel Ch remotest from the light-receiving element 11a are caused to emit light, differences in distance to the light-receiving element 11a among the light-emitting channels Ch can be cancelled out and a proper driving current target value can be obtained.

Specifically, in this case, a value obtained by multiplying the driving current target value, which is calculated by light emission of the two light-emitting channels Ch in the APC processing, by a coefficient m/s is set as a driving current value during normal ranging. In this case, s is the number of light-emitting channels Ch (the total number of light-emitting channels Ch) for light emission during normal ranging. In other words, the coefficient in this case is “½” from 2/4. During zone ranging, a value obtained by multiplying the driving current target value, which is calculated in the APC processing, by the coefficient n/m, that is, “2/1=2” is set as a driving current value.

Thus, during normal ranging and zone ranging, an amount of irradiated light per unit time for the ranging area can be set at a proper amount as an upper-limit amount (“4” in the foregoing example).

In this example, as the light-emitting channels Ch to emit light during APC processing, the number of light-emitting channels Ch near the light-receiving element 11a is one and the number of light-emitting channels Ch remote from the light-receiving element 11a is one on the assumption that the total number of light-emitting channels Ch is four. If the number of light-emitting channels Ch is an even number, e.g., six or more, the plurality of light-emitting channels Ch may be provided near the light-receiving element 11a to emit light during APC processing, and the plurality of light-emitting channels Ch may be provided remote from the light-receiving element 11a. As described above, the value of m is not limited to 2 and may be 4 or larger as a multiple of 2.

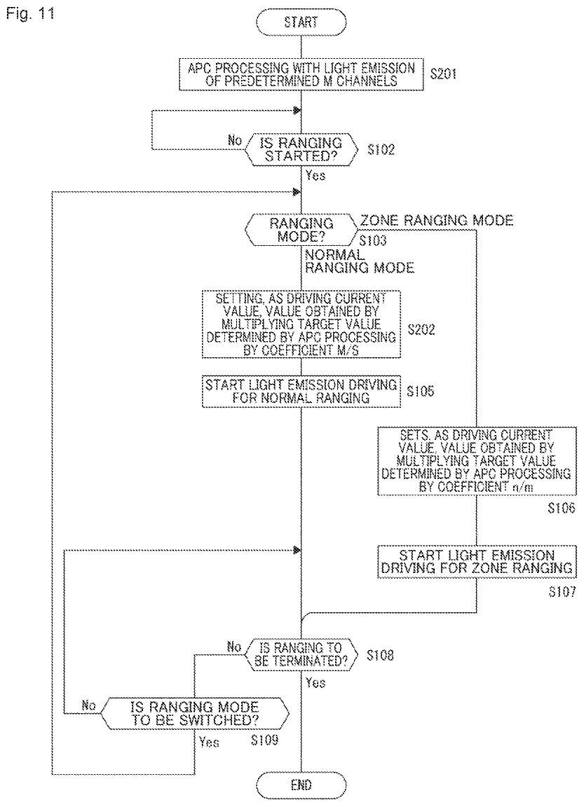

The flowchart of FIG. 11 shows a specific procedure example for implementing a light emission control technique as a modification example of the first embodiment.

In the following description, parts similar to those in the foregoing description will be denoted by the same reference numerals and step numbers, and the description thereof is omitted.

In FIG. 11, the control unit 14 in this case performs APC processing in step S201 instead of the APC processing in step S101. Specifically, processing is performed to determine a driving current target value on the basis of a light-receiving signal obtained by light emission of the m light-emitting channels Ch.

In this case, if it is determined that the ranging mode is the normal ranging mode in step S103, the control unit 14 performs processing in step S202 instead of the processing in step S104. In other words, the control unit 14 performs processing for setting, as a driving current value, a value obtained by multiplying the target value determined by the APC processing by the coefficient m/s.

Also in this case, if it is determined that the ranging mode is the zone ranging mode in step S103, the control unit 14 performs the processing in step S106. In other words, the control unit 14 performs processing for setting, as a driving current value, a value obtained by multiplying the target value determined by the APC processing by the coefficient n/m (2/1=2 in the example of FIG. 10).

In this example, the coefficient for determining the driving current value of the light-emitting channels Ch during partial light-emitting ranging, that is, the coefficient for a multiplication on the target value determined by the APC processing is “n/m”. The coefficient may be determined according to, for example, how long the maximum ranging distance is to be extended during normal ranging, and the coefficient is not limited to “n/m”.

### 2. Second Embodiment

A second embodiment relates to ranging by spot light emission.

The spot light emission means a light emission pattern for irradiating an object Ob with irradiated light Li in a dot pattern as disclosed in, for example, reference document 2. The shapes of dots in the dot pattern are not limited to circles and may include shapes other than a circle, for example, an ellipse.
Reference document 2: JP 2021-34239A

In the normal ranging described in the first embodiment, the object Ob is irradiated with the irradiated light Li with a substantially uniform illumination distribution through a diffuser 20.

A light emission pattern for irradiating the object Ob with the irradiated light Li with a substantially uniform illumination distribution will be referred to as “surface emission” relative to the spot light emission.

Hereinafter, a ranging technique for ranging on the basis of the reflected light Lr obtained by spot light emission will be referred to as “spot ranging”.

In normal ranging with surface emission, the resolution of a depth map is improved by using diffused light. The multipath influence of the reflected light Lr (multiple reflections) may interfere with proper acquisition of ranging information depending upon, for example, the shape of the object Ob. Specifically, the multipath of the reflected light Lr is likely to occur at, for example, the corners of a room, leading to difficulty in obtaining proper ranging information. In spot ranging with light emission in a dot pattern, the diffusion of light is suppressed on each dot. Thus, the multipath of the reflected light Lr is unlikely to occur, thereby obtaining correct ranging information also at the corners of a room. However, ranging is performed only on the basis of the reflected light Lr on dotted portions, so that the resolution of a depth map tends to decrease.

Thus, a ranging technique using normal ranging with surface emission and spot ranging is proposed.

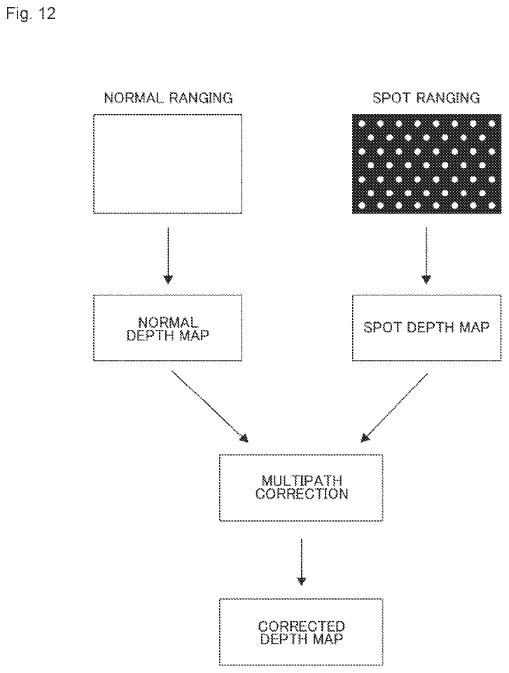

Specifically, as illustrated in FIG. 12, a multipath is corrected by using a normal depth map obtained by normal ranging with surface emission and a spot depth map obtained by spot ranging. Specifically, in the multipath correction, distance information on an image part including less reliable distance information obtained by the influence of multipath in a normal depth map is corrected on the basis of distance information obtained in the corresponding image part of a spot depth map.

A known technique may be used for multipath correction based on a spot depth map and is not particularly limited. For example, a technique disclosed in reference document 3 may be adopted.
Reference document 3: Specification of US Patent Application Publication No. 2013/0148102

The corrected depth map obtained by multipath correction is assumed to be an image with a resolution improved by surface emission and ranging accuracy improved in a multipath part.

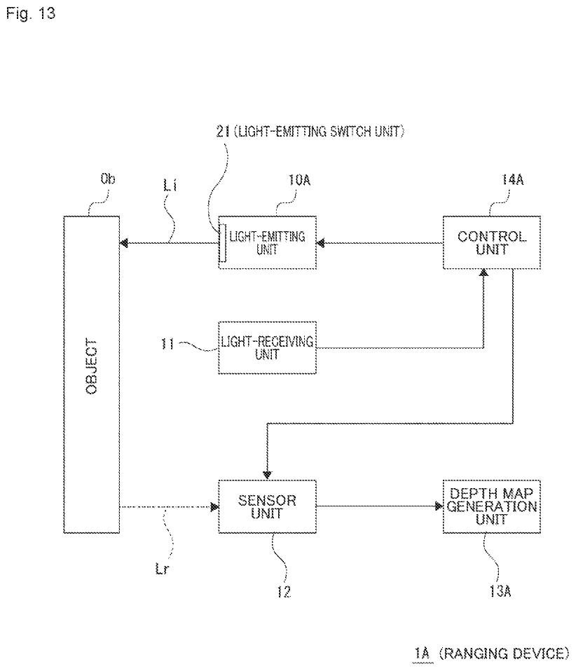

FIG. 13 is a block diagram for explaining a configuration example of a ranging device 1A according to the second embodiment configured to obtain the corrected depth map.

A difference from the ranging device 1 of the first embodiment in FIG. 1 is that a light-emitting unit 10A is provided instead of the light-emitting unit 10, a control unit 14A is provided instead of the control unit 14, and a depth map generation unit 13A is provided instead of the depth map generation unit 13.

The light-emitting unit 10A is different from the light-emitting unit 10 in the provision of an irradiated light switching unit 21.

The irradiated light switching unit 21 switches surface emission and spot light emission for the light emission pattern of the light-emitting unit 10A.

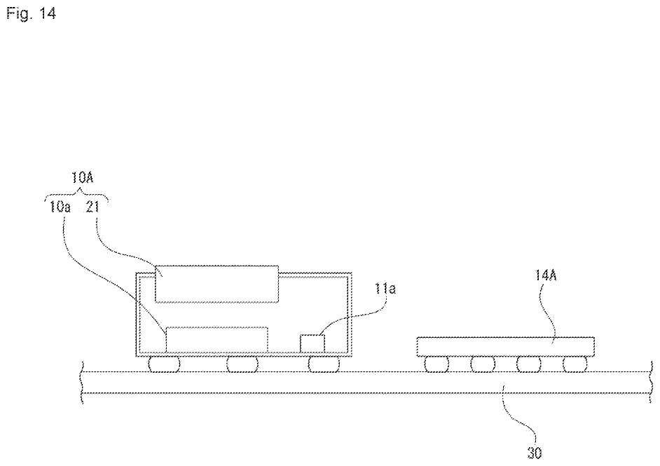

FIG. 14 is an explanatory diagram of a structural configuration example of the light-emitting unit 10A.

As illustrated in FIG. 14, the light-emitting unit 10A includes the irradiated light switching unit 21 disposed above an emission unit 10a. Thus, for the irradiated light Li from the light-emitting unit 10A, the irradiated light Li with surface emission and the irradiated light Li with spot light emission can be switched with the emission unit 10a serving as a light source.

The irradiated light switching unit 21 may be configured in various forms and is not limited to a specific configuration. For example, as disclosed in reference document 2 described above, a configuration for switching surface emission and spot light emission by focusing may be adopted. Alternatively, a configuration for switching surface emission and spot light emission by using a liquid crystal panel may be adopted.

In this case, the light-receiving element 11a receives light emitted from the emission unit 10a and reflected by the irradiated light switching unit 21.

FIG. 14 illustrates a semiconductor device as the control unit 14A. In this example, the semiconductor device as the control unit 14A is mounted on a circuit board 30 along with a semiconductor device in which the light-emitting unit 10A and the light-receiving element 11a are disposed.

In FIG. 13, the control unit 14A is different from the control unit 14 in the provision of the function of controlling the light-emitting unit 10A to perform a light emitting operation for implementing spot ranging as well as normal ranging.

Specifically, the control unit 14A controls the irradiated light switching unit 21 to cause surface emission from the light-emitting unit 10A during a normal ranging mode for performing normal ranging, and controls the irradiated light switching unit 21 to cause spot light emission from the light-emitting unit 10A during a spot ranging mode for performing spot ranging.

At this point, the control unit 14A causes light emission during surface emission and spot light emission with equal numbers of the light-emitting elements 101. Specifically, in this example, all the light-emitting elements 101 in the light-emitting unit 10A are caused to emit light during surface emission and spot light emission.

Furthermore, the control unit 14A performs processing for setting the corrected target value of a driving current target value obtained by APC processing, as a driving current value of the light-emitting unit 10A during spot ranging.

In this example, the APC processing is performed with surface emission from the light-emitting unit 10A. In this case, a basic irradiated light amount during spot light emission is different from a basic irradiated light amount in a calculation light emission period. Specifically, the basic irradiated light amount during spot light emission is smaller than a basic irradiated light amount during surface emission because an irradiation region is sparsely provided.

Thus, the driving current target value, which is determined by APC processing, during surface emission is corrected such that a difference in basic irradiated light amount is set at a proper difference by, for example, offsetting the basic irradiated light amount, and the corrected target value is set as a driving current value during spot light emission.

In this case, a coefficient used for correcting the driving current target value may be experimentally determined on the basis of a difference in basic irradiated light amount between surface emission and spot light emission. Specifically, for an amount of irradiated light per unit time for the ranging area, a coefficient is determined by an experiment such that an amount of irradiated light during spot light emission can be matched with an amount of irradiated light during surface emission.

In FIG. 13, the depth map generation unit 13A generates a corrected depth map by performing the multipath correction on the basis of a normal depth map and a spot depth map that are obtained by the sensor unit 12 in this case.

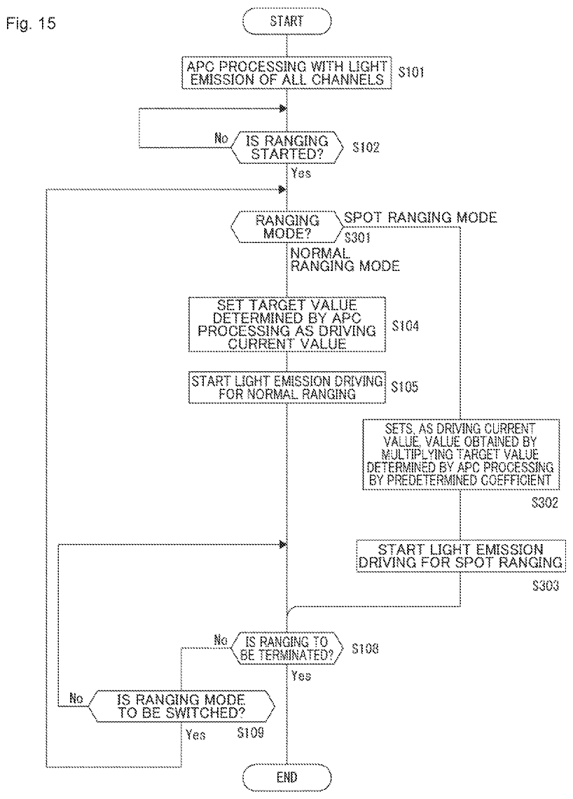

The flowchart of FIG. 15 shows a specific procedure example for implementing a light emission control technique as a modification example of the second embodiment.

In step S101, the control unit 14A performs APC processing with light emission of all the channels. Specifically, processing for calculating a driving current target value is performed on the basis of the light-receiving signal of the light-receiving element 11a, the light-receiving signal being obtained by light emission of all the light-emitting elements 101 in the light-emitting unit 10A.

In step S102 subsequent to step S101, the control unit 14A waits for the start of ranging. When it is determined that ranging is started, the control unit 14A determines whether the ranging mode is the normal ranging mode or the spot ranging mode as ranging mode determination of step S301.

The flow of processing in the normal ranging mode is similar to that of FIG. 9, and thus a duplicate description thereof is avoided. In this case, however, the irradiated light switching unit 21 is controlled to cause surface emission from the light-emitting unit 10A during normal ranging.

In the case of the spot ranging mode, the control unit 14A advances to step S302 and performs processing for setting, as a driving current value, a value obtained by multiplying the target value determined by the APC processing by a predetermined coefficient. In other words, the coefficient determined by an experiment is used as the predetermined coefficient, and a value obtained by multiplying the target value calculated in step S101 by the predetermined value is set as a driving current value during spot light emission.

In step S303 subsequent to step S302, the control unit 14A starts light emission driving for spot ranging. Specifically, processing is performed to control the irradiated light switching unit 21 to cause spot light emission from the light-emitting unit 10A and control all the light-emitting elements 101 in the light-emitting unit 10A to perform a light emitting operation for ranging (a light emitting operation by the repeated light emission) by the driving current value set in step S302.

The control unit 14A advances the processing to step S108 in response to the execution of the processing of step S303.

If it is determined that the ranging mode is to be switched in step S109, the control unit 14A returns to the ranging mode determination of step S301. Thus, proper light emission control is performed according to the normal ranging mode and the spot ranging mode.

Using the light emission control technique as the second embodiment eliminates the need for calculating a driving current target value for both of surface emission and spot light emission when a ranging technique is used with surface emission and spot emission to obtain a depth map.

This can reduce power consumption when a ranging technique is implemented with surface emission and spot light emission.

In the foregoing example, light is emitted by equal numbers of the light-emitting elements 101 during the calculation light emission period (a light emission period in APC processing) and spot light emission. Light may be emitted by different numbers of the light-emitting elements 101 during the calculation light emission period and spot light emission.

### 3. Modification Example

The embodiment is not limited to the foregoing specific examples. Configurations as a variety of modification examples can be adopted.

For example, in the foregoing example, the light emission control technique according to the present technique is applied to ranging according to the ToF method. The present technique is not limited to the ToF method and is widely and properly applied to ranging methods in which a distance is measured by receiving reflected light from the object Ob.

Moreover, in the foregoing example, a VCSEL is used as the light-emitting element 101. The present technique is also properly applicable to other semiconductor light-emitting elements, for example, semiconductor lasers other than a VCSEL.

### 4. Summary of Embodiments

As described above, the light-emitting device as the embodiment includes a light-emitting unit (10 or 10A) that emits light for ranging, a light-receiving unit (10) that receives light emitted from the light-emitting unit, and a control unit (14 or 14A) that calculates a target value of the driving current of the light-emitting unit on the basis of a light-receiving signal by the light-receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period.

As described above, “basic irradiated light amount” means an amount of light to the object when the driving current value of the light-emitting unit is set at a constant value. “When the light-emitting unit is caused to emit light with a different basic irradiated light amount from the calculation light emission period” may specifically correspond to light emission by the light-emitting unit with a different number of light-emitting channels from the calculation light emission period. Alternatively, spot light emission (light emission in a dot pattern) may be used in contrast to surface emission in the calculation light emission period. In either case, the object is irradiated with different amounts of irradiated light if the driving current value of the light-emitting unit has the same value as in the calculation light emission period, which corresponds to “when the light-emitting unit is caused to emit light with a different basic irradiated light amount from the calculation light emission period”.

As described above, when the light-emitting unit is caused to emit light with a different basic irradiated light amount from the calculation light emission period, the light-emitting unit is caused to emit light by the driving current according to the corrected target value based on a difference in basic irradiation light amount from the calculation light emission period. Thus, also in the case of light emission with a different basic irradiated light amount from the calculation light emission period, a difference in basic irradiated light amount can be properly corrected, thereby driving the light-emitting unit to achieve a proper amount of irradiated light. Thus, for example, when a ranging technique of sequential light emission of some of the light-emitting channels is adopted to obtain a depth map as in zone ranging, the need for calculating a driving current target value (calibration) for each of the light-emitting channels is eliminated. When a ranging technique of surface emission and spot light emission is adopted to obtain a depth map, the need for calculating a driving current target value for both of surface emission and spot light emission is eliminated. Since it is not necessary to calculate a driving current target value for each emission for ranging, thereby reducing power consumption.

Moreover, in the light-emitting device as the embodiment, the light-emitting unit includes a plurality of light-emitting channels, and the control unit (14) controls some of the light-emitting channels to emit light by a driving current according to the corrected target value obtained for some of the light-emitting channels during partial light-emitting ranging in which only some of the light-emitting channels are caused to emit light to measure a distance.

Thus, for example, when a ranging technique of sequential light emission of some of the light-emitting channels is adopted to obtain a depth map as in zone ranging, the need for calculating a driving current target value (calibration) for each of the light-emitting channels is eliminated. Thus, it is not necessary to place a light-receiving element for each of the light-emitting channels.

Thus, the size and cost of the light-emitting device can be reduced.

Since it is not necessary to calculate a driving current target value for each of the light-emitting channels, the number of times of ranging can be increased per unit time, thereby improving the accuracy of ranging.

Moreover, in the light-emitting device as the embodiment, from among the plurality of light-emitting channels, the control unit causes at least the light-emitting channel closest to the light-receiving unit and the light-emitting channel remotest from the light-receiving unit to emit light in the calculation light emission period.

Thus, even if the single light-emitting element is provided in the light-receiving unit, a target value can be properly calculated.

This can improve the accuracy of a corrected target value.

Moreover, in the light-emitting device as the embodiment, the control unit causes all the light-emitting channels in the light-emitting unit to emit light in the calculation light emission period. Thus, even if the single light-emitting element is provided in the light-receiving unit, a target value can be more properly calculated.

This can improve the accuracy of a corrected target value.

Moreover, in the light-emitting device as the embodiment, the control unit controls the m light-emitting channels to emit light by a driving current according to a corrected target value obtained by multiplying the target value by a coefficient n/m during partial light-emitting ranging, where n is the number of light-emitting channels for light emission in the calculation light emission period and m is the number of light-emitting channels for light emission during the partial light-emitting ranging.

Thus, during partial light-emitting ranging, the intensity of irradiated light can be higher than in normal ranging in which a distance is measured by light emission of all the light-emitting channels.

Thus, the maximum ranging distance can be larger than that of normal ranging.

Moreover, in the light-emitting device as the embodiment, the control unit controls all the light-emitting channels in the light-emitting unit to emit light in the calculation light emission period, only one of the light-emitting channels in the light-emitting unit to emit light during the partial light-emitting ranging, and the one of the light-emitting channels to emit light by a driving current according to the corrected target value obtained by multiplying the target value by the total number of light-emitting channels in the light-emitting unit.

Thus, when the number of light-emitting channels for light emission is one during the partial light-emitting ranging, a proper corrected target value can be obtained by correcting a proper target value, which is obtained by light emission of all the light-emitting channels during the calculation light emission period, by a proper coefficient.

Thus, the accuracy of ranging can be improved.

Moreover, in the light-emitting device as the embodiment, the light-emitting unit (10A) is configured to switch surface emission and spot light emission, and the control unit calculates the target value with the surface emission from the light-emitting unit in the calculation light emission period, and causes the light-emitting unit to emit light, in the case of spot light emission from the light-emitting unit, by a driving current according to a corrected target value obtained by correcting the target value on the basis of the difference in basic irradiated light amount.

Thus, when a ranging technique of surface emission and spot light emission is adopted to obtain a depth map, the need for calculating a driving current target value for both of surface emission and spot light emission is eliminated.

This can reduce power consumption when a ranging technique is implemented with surface emission and spot light emission.

Moreover, in the light-emitting device as the embodiment, the light-emitting unit includes a plurality of light-emitting elements, and light is emitted by equal numbers of the light-emitting elements during the calculation light emission period and the spot light emission.

Thus, the corrected target value used for spot light emission can be properly determined. This can improve the accuracy of ranging by spot light emission.

The light-emitting device (1 or 1A) as the embodiment includes a light-emitting unit that emits light for ranging, a ranging unit (the sensor unit 12, the depth map generation unit 13 or 13A) that measures a distance to an object by receiving light emitted from the light-emitting unit and reflected by the object, and a control unit that calculates a target value of the driving current of the light-emitting unit on the basis of a light-receiving signal by the light-receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period. The ranging device configured thus can obtain the same operations and effects as the light-emitting device according to the embodiments.

In the ranging device as the embodiment, the ranging unit measures a distance according to the ToF method.

Thus, the need for calculating a driving current target value for each emission for ranging is eliminated for ranging according to the ToF method.

This can reduce the power consumption of the ranging device for measuring a distance according to the ToF method.

The advantageous effects described in the present specification are merely exemplary and are not limited, and other advantageous effects may be obtained.

### <8. Present Technique>

The present technique can also be configured as follows:

(1)

A light-emitting device including: a light-emitting unit that emits light for ranging;
a light-receiving unit that receives light emitted from the light-emitting unit; and
a control unit that calculates a target value of the driving current of the light-emitting unit on the basis of a light-receiving signal by the light-receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period.
   (2)

The light-emitting device according to (1), wherein the light-emitting unit includes a plurality of light-emitting channels, and
the control unit controls some of the light-emitting channels to emit light by a driving current according to the corrected target value obtained for some of the light-emitting channels during partial light-emitting ranging in which only some of the light-emitting channels are caused to emit light to measure a distance.
   (3)

The light-emitting device according to (2), wherein from among the plurality of light-emitting channels, the control unit causes at least the light-emitting channel closest to the light-receiving unit and the light-emitting channel remotest from the light-receiving unit to emit light in the calculation light emission period.

(4)

The light-emitting device according to (3), wherein the control unit causes all the light-emitting channels in the light-emitting unit to emit light in the calculation light emission period.

(5)

The light-emitting device according to any one of (2) to (4), wherein the control unit controls the m light-emitting channels to emit light by a driving current according to the corrected target value obtained by multiplying the target value by a coefficient n/m during partial light-emitting ranging,
where n is the number of light-emitting channels for light emission in the calculation light emission period and m is the number of light-emitting channels for light emission during the partial light-emitting ranging.
   (6)

The light-emitting device according to (5), wherein the control unit controls all the light-emitting channels in the light-emitting unit to emit light in the calculation light emission period, only one of the light-emitting channels in the light-emitting unit to emit light during the partial light-emitting ranging, and the one of the light-emitting channels to emit light by a driving current according to the corrected target value obtained by multiplying the target value by the total number of light-emitting channels in the light-emitting unit.

(7)

The light-emitting device according to (1), wherein the light-emitting unit is configured to switch surface emission and spot light emission, and
the control unit calculates the target value with the surface emission from the light-emitting unit in the calculation light emission period, and causes the light-emitting unit to emit light, in the case of spot light emission from the light-emitting unit, by a driving current according to a corrected target value obtained by correcting the target value on the basis of the difference in basic irradiated light amount.
   (8)

The light-emitting device according to (7), wherein the light-emitting unit includes a plurality of light-emitting elements, and
light is emitted by equal numbers of the light-emitting elements during the calculation light emission period and the spot light emission.
   (6)

A ranging device including: a light-emitting unit that emits light for ranging;
a ranging unit that measures a distance to an object by receiving light emitted from the light-emitting unit and reflected by the object;
a light-receiving unit that receives light emitted from the light-emitting unit; and
a control unit that calculates a target value of the driving current of the light-emitting unit on the basis of a light-receiving signal by the light-receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period.
   (10)

The ranging device according to (9), wherein the ranging unit measures a distance according to the ToF method.

### REFERENCE SIGNS LIST

1, 1A Ranging device
10, 10A Light emitting unit
10a Emission unit
101 Light-emitting element
11 Light-receiving unit
11a Light-receiving element
12 Sensor unit
13, 13A Depth map generation unit
14, 14A Control unit
20 Diffuser
21 Irradiated light switching unit
30 Circuit board
Ob Object
Li Irradiated light
Lr Reflected light
Ch, Ch1, Ch2, Ch3, Ch4 Light-emitting channel
Z, Z1, Z2, Z3, Z4 Zone

1. A light-emitting device comprising: a light-emitting unit that emits light for ranging;
a light-receiving unit that receives light emitted from the light-emitting unit; and
a control unit that calculates a target value of a driving current of the light-emitting unit on the basis of a light-receiving signal by the light-receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period.

2. The light-emitting device according to claim 1, wherein the light-emitting unit includes a plurality of light-emitting channels, and
the control unit controls some of the light-emitting channels to emit light by a driving current according to the corrected target value obtained for some of the light-emitting channels during partial light-emitting ranging in which only some of the light-emitting channels are caused to emit light to measure a distance.

3. The light-emitting device according to claim 2, wherein from among the plurality of light-emitting channels, the control unit causes at least the light-emitting channel closest to the light-receiving unit and the light-emitting channel remotest from the light-receiving unit to emit light in the calculation light emission period.

4. The light-emitting device according to claim 3, wherein the control unit causes all the light-emitting channels in the light-emitting unit to emit light in the calculation light emission period.

5. The light-emitting device according to claim 2, wherein the control unit controls the m light-emitting channels to emit light by a driving current according to the corrected target value obtained by multiplying the target value by a coefficient n/m during the partial light-emitting ranging,
where n is the number of light-emitting channels for light emission in the calculation light emission period and m is the number of light-emitting channels for light emission during the partial light-emitting ranging.

6. The light-emitting device according to claim 5, wherein the control unit controls all the light-emitting channels in the light-emitting unit to emit light in the calculation light emission period, only one of the light-emitting channels in the light-emitting unit to emit light during the partial light-emitting ranging, and the one of the light-emitting channels to emit light by a driving current according to the corrected target value obtained by multiplying the target value by the total number of light-emitting channels in the light-emitting unit.

7. The light-emitting device according to claim 1, wherein the light-emitting unit is configured to switch surface emission and spot light emission, and
the control unit calculates the target value with the surface emission from the light-emitting unit in the calculation light emission period, and causes the light-emitting unit to emit light, in the case of the spot light emission from the light-emitting unit, by a driving current according to a corrected target value obtained by correcting the target value on the basis of the difference in basic irradiated light amount.

8. The light-emitting device according to claim 7, wherein the light-emitting unit includes a plurality of light-emitting elements, and
light is emitted by equal numbers of the light-emitting elements during the calculation light emission period and the spot light emission.

9. A ranging device comprising: a light-emitting unit that emits light for ranging;
a ranging unit that measures a distance to an object by receiving light emitted from the light-emitting unit and reflected by the object;
a light-receiving unit that receives light emitted from the light-emitting unit; and
a control unit that calculates a target value of the driving current of the light-emitting unit on the basis of a light-receiving signal by the light-receiving unit and causes the light-emitting unit to emit light by a driving current according to a corrected target value obtained by correcting the target value on the basis of a difference in basic irradiation light amount from a calculation light emission period, during which the light-emitting unit is caused to emit light for calculating the target value, when the light-emitting unit is caused to emit light with a different basic irradiated light amount from the calculation light emission period.

10. The ranging device according to claim 9, wherein the ranging unit measures a distance according to a ToF method.
